(19) United States
(12) Patent Application Publication
(10) Pub. No.: US 2024/0136822 A1
(43) Pub. Date: Apr. 25, 2024

(54) AC SIDE ANTI-BACKFLOW CONTROL METHOD AND TERMINAL

(71) Applicant: CONTEMPORARY NEBULA TECHNOLOGY ENERGY CO.,Ltd., Fuzhou (CN)

(72) Inventors: Zhengping SHI, Fuzhou (CN); Yanqi FANG, Fuzhou (CN)

(73) Assignee: CONTEMPORARY NEBULA TECHNOLOGY ENERGY CO.,Ltd., Fuzhou (CN)

(21) Appl. No.: 18/400,931

(22) Filed: Dec. 29, 2023

Related U.S. Application Data
(63) Continuation of application No. PCT/CN2022/070033, filed on Jan. 4, 2022.

(30) Foreign Application Priority Data
Dec. 27, 2021 (CN) 202111616347.5

(51) Int. Cl. H02J 3/32; H02J 3/00

(52) U.S. Cl. CPC H02J 3/32; H02J 3/0012; H02J 2203/10

(57) ABSTRACT

Disclosed are an AC side anti-backflow control method and a terminal. The method includes: obtaining an electrical parameter of an intelligent microgrid; and calculating a correction coefficient according to the electrical parameter, and performing correction and control on power of a battery system side of the intelligent microgrid according to the correction coefficient. By utilizing the correction coefficient, it is ensured that the battery system side operates on the basis of an originally set power, and it is also ensured that when the power of the battery system side in a time segmented configuration changes, an adjustment power that collects power feedback in real-time changes following the power of the battery system side in the time segmented configuration.

### CROSS-REFERENCE TO RELATED APPLICATIONS

This application is a continuation of International Application No. PCT/CN2022/070033, filed on Jan. 4, 2022, which claims priority to Chinese Patent Application No. 202111616347.5, filed on Dec. 27, 2021. All of the aforementioned applications are incorporated herein by reference in their entireties.

### TECHNICAL FIELD

The present disclosure relates to the technical field of energy storage systems, and in particular to an AC side anti-backflow control method and a terminal.

### BACKGROUND

With the increasing popularity of various new types of power devices such as intelligent floor heating, intelligent projection, etc. in residential homes, the daily electricity consumption and the peak power of each household are increasing. At the same time, in accordance with the Smart Manufacturing Plan for 2025, the equipment in domestic plants has gradually entered the pace of upgrading, replacing the old equipment with more intelligent and higher power equipment, and the daily electricity consumption and peak power of commercial electricity are also increasing.

The load pressure of the power grid increases sharply, and as China aims to peak carbon dioxide emissions by 2030, the thermal power plants are gradually shut down, and the power supply is strained, resulting in the situation that the commercial electricity is limited. To this end, the prior art uses energy storage system and green power generation equipment such as photovoltaic, wind power or hydrogen fuel power generation system to constitute an intelligent microgrid, which can effectively reduce the peak load of the power grid by regulating the energy flow, reduce the load pressure of the power grid, and play the role of peak regulation.

However, when the AC bus is used for capacity expansion, the EMS (Energy Management System) of energy storage needs to mobilize the energy of the energy storage system according to the data collected in real time because of the energy fluctuation of the load and the power generation system. When an energy scheduling system performs data collection and energy scheduling, with reference to FIG. 1, most existing systems in previous intelligent microgrids do not contain a second power generation system other than energy storage system and most existing systems only. The microgrid contains an energy storage system, a power grid and a load, and the EMS will collect power at the power grid side in real time, and the energy storage system outputs power in a fixed period of time. In the case of sudden load drop and backflow on the power grid side, the EMS will reduce the output power of the energy storage system, to the minimum of 0. If it cannot be adjusted back within a certain time, the contactor on battery system side is cut off, so as to ensure that the stored current does not continue to flow back to the power grid.

However, the existing scheduling method has the following two problems.

First, if there is a second power generation system in the microgrid, since there is a second power generation system in the microgrid, even if the discharge power of the energy storage system drops to 0 and AC contactor connected between the energy storage system and the power grid is cut off, the backflow of the power generation system cannot be prevented. When the power generation system flows back to the power grid, it will cause fluctuations in the power grid, which will greatly affect the stability of the power grid.

Second, when a power grid scheduling instruction is sent to the EMS, a real-time sampling result may also be sent to the EMS at the same time, resulting in a conflict between the two instructions, and the EMS cannot decide whether it should respond to the scheduling instruction or the result of real-time feedback, resulting in a system error and unable to achieve scheduling management.

Due to the above two problems, the current of an intelligent microgrid flows back to a power grid.

### SUMMARY

The technical problem to be solved by the present disclosure is: an AC side anti-backflow control method and a terminal can better prevent the current of an intelligent microgrid from flowing back to a power grid.

In order to solve the above technical problem, one technical solution adopted by the present disclosure is: an AC anti-backflow control method, including the steps of:
step S1, obtaining an electrical parameter of an intelligent microgrid; and
step S2, calculating a correction coefficient according to the electrical parameter, and performing correction and control on power of a battery system side of the intelligent microgrid according to the correction coefficient.

In order to solve the above technical problem, another technical solution adopted by the present disclosure is: an AC side anti-backflow control terminal, including a memory, a processor and a computer program stored on the memory and executable on the processor, the processor implementing the following steps when executing the computer program:
step S1, obtaining an electrical parameter of an intelligent microgrid; and
step S2, calculating a correction coefficient according to the electrical parameter, and performing correction and control on power of a battery system side of the intelligent microgrid according to the correction coefficient.

The advantageous effect of the present disclosure is that: an AC side anti-backflow control method and a terminal are disclosed. By utilizing the correction coefficient, it is ensured that the battery system side operates on the basis of an originally set power, and it is also ensured that when the power of the battery system side in a time segmented configuration changes, an adjustment power that collects power feedback in real-time changes following the power of the battery system side in the time segmented configuration; said strategy ensures that issued power does not conflict with power to be adjusted that is collected in real time, and the battery system side operates in accordance with the originally set power, only performing correction by multiplying the power by a coefficient.

### BRIEF DESCRIPTION OF THE DRAWINGS

FIG. 1 is a schematic structural diagram of an intelligent microgrid according to the prior art in which a power generation system is located at a battery system side.

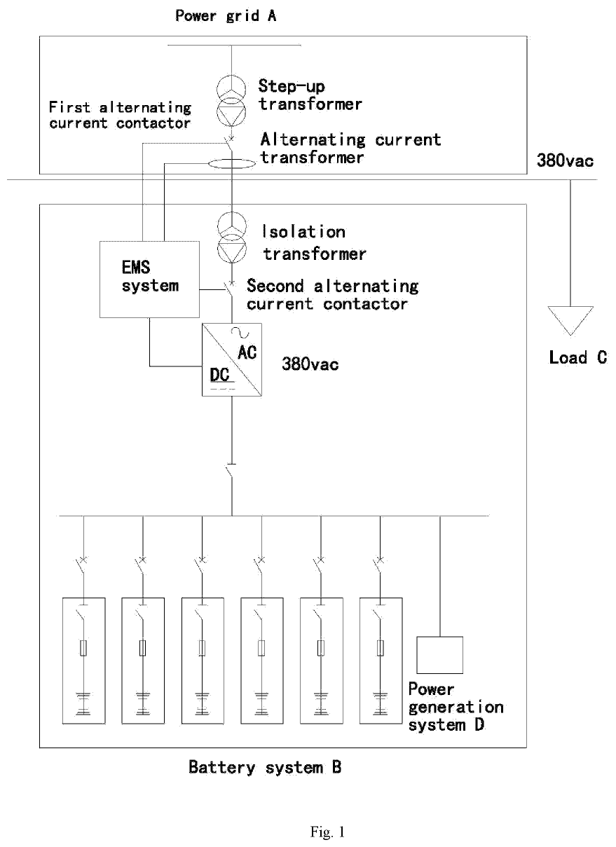

FIG. 2 is a procedure flow chart of an AC side anti-backflow control method according to the present disclosure.

FIG. 3 is a schematic structural diagram of an intelligent microgrid according to the present disclosure in which a power generation system is directly connected to an AC bus.

FIG. 4 is a schematic structural diagram of an AC side anti-backflow control terminal according to the present disclosure.

### DETAILED DESCRIPTION OF THE EMBODIMENTS

In order to explain the technical contents, the objects, and the effects of the present disclosure in detail, the following is illustrated in combination with the embodiments and the accompanying drawings.

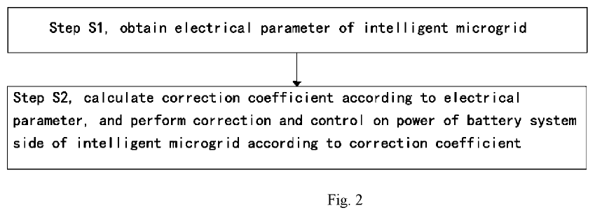

With reference to FIG. 2, an AC side anti-backflow control method according to an embodiment of the present disclosure includes the steps of:
step S1, obtaining an electrical parameter of an intelligent microgrid; and
step S2, calculating a correction coefficient according to the electrical parameter, and performing correction and control on power of a battery system side of the intelligent microgrid according to the correction coefficient.

As can be seen from the above, the advantageous effect of the present disclosure is that: an AC side anti-backflow control method and a terminal are disclosed. By utilizing the correction coefficient, it is ensured that the battery system side operates on the basis of an originally set power, and it is also ensured that when the power of the battery system side in a time segmented configuration changes, an adjustment power that collects power feedback in real-time changes following the power of the battery system side in the time segmented configuration; the strategy mentioned ensures that issued power does not conflict with power to be adjusted that is collected in real time, and the battery system side operates in accordance with the originally set power, only performing correction by multiplying the power by a coefficient.

Further, the electrical parameter includes a power of the power grid side of the intelligent microgrid that is collected in real time, a set power of the battery system side, and a set power of the current power grid side.

Specifically, a correction coefficient is calculated according to the power Pw of the power grid side that is collected in real time, the set power P1 of the battery system side at the previous moment and the set power Pc of the current power grid side, so as to better adjust the power of the battery system side of the microgrid, and to prevent the current from flowing back to the power grid.

Further, in the step S2, the correction coefficient is calculated and obtained according to the formula A=(Pw−Pc)/P1, where A is the correction coefficient; the correction and control are performed on power of battery system side of intelligent microgrid according to the formula P=A*P2, where P2 is the set power of the battery system side at the current moment, and P is the power set by the command finally sent to the battery system side, i.e., the power finally output by the battery system side.

As can be seen from the above, using the difference between the power Pw of the power grid side that is collected in real time and the set power Pc of the power grid side as a correction coefficient not only prevents the current from flowing back to the power grid, but also enables the power of the power grid to be controlled at the set power.

Further, when the power Pw of the power grid side that is collected in real time is less than the set power Pr of the power grid backflow, and the duration T exceeds the set backflow time Tc, the intelligent microgrid is controlled to cut off the electrical connection with the power grid.

As can be seen from the above, when the duration T that Pw<Pr exceeds Tc, that is T>Tc, it indicates that there is also backflow power after power control, the electrical connection between the power grid side and the intelligent microgrid needs to be cut off timely to ensure that there is no current flowing back to the power grid and ensure the stability of the power grid.

Further, the set power of the battery system side and the set power of the current power grid side are set according to the current time segment. As can be seen from the above, the set power of the battery system side and the set power of the power grid side are set in a time segmented configuration, which can adapt to the power consumption demand and the power grid price in different time segments of a day, and achieve peak shaving and valley filling.

An AC side anti-backflow control terminal includes a memory, a processor and a computer program stored on the memory and executable on the processor, the processor implementing the following steps when executing the computer program:
step S1, obtaining an electrical parameter of an intelligent microgrid; and
step S2, calculating a correction coefficient according to the electrical parameter, and performing correction and control on power of a battery system side of the intelligent microgrid according to the correction coefficient.

As can be seen from the above, the advantageous effect of the present disclosure is that: an AC side anti-backflow control method and a terminal are disclosed. By utilizing the correction coefficient, it is ensured that the battery system side operates on the basis of an originally set power, and it is also ensured that when the power of the battery system side in a time segmented configuration changes, an adjustment power that collects power feedback in real-time changes following the power of the battery system side in the time segmented configuration; the strategy mentioned ensures that issued power does not conflict with power to be adjusted that is collected in real time, and the battery system side operates in accordance with the originally set power, only performing correction by multiplying the power by a coefficient.

Further, the electrical parameter includes a power of the power grid side of the intelligent microgrid that is collected in real time, a set power of the battery system side, and a set power of the current power grid side.

Specifically, a correction coefficient is calculated according to the power Pw of the power grid side that is collected in real time, the set power P1 of the battery system side at the previous moment and the set power Pc of the current power grid side, so as to better adjust the power of the battery system side of the microgrid, and to prevent the current from flowing back to the power grid.

Further, in the step S2, the correction coefficient is calculated and obtained according to the formula A=(Pw−Pc)/P1, where A is the correction coefficient; the correction and control are performed on power of battery system side of intelligent microgrid according to the formula P=A*P2, where P2 is the set power of the battery system side at the current moment, and P is the power set by the command finally sent to the battery system side.

As can be seen from the above, using the difference between the power Pw of the power grid side that is collected in real time and the set power Pc of the power grid side as a correction coefficient not only prevents the current from flowing back to the power grid, but also enables the power of the power grid to be controlled at the set power.

Further, when the power Pw of the power grid side that is collected in real time is less than the set power Pr of the power grid backflow, and the duration T exceeds the set backflow time Tc, the intelligent microgrid is controlled to cut off the electrical connection with the power grid.

As can be seen from the above, when the duration T that Pw<Pr exceeds Tc, that is T>Tc, it indicates that there is also backflow power after power control, the electrical connection between the power grid side and the intelligent microgrid needs to be cut off timely to ensure that there is no current flowing back to the power grid and ensure the stability of the power grid.

Further, the set power of the battery system side and the set power of the current power grid side are set according to the control time segment. As can be seen from the above, the set power of the battery system side and the set power of the power grid side are set in a time segmented configuration, which can adapt to the power consumption demand and the power grid price in different time segments of a day, and achieve peak shaving and valley filling.

The present disclosure is used in an intelligent microgrid system to coordinate and control the output of an energy storage system so as to prevent the current of the intelligent microgrid from flowing back to the power grid.

### Embodiment 1

With reference to FIG. 2, an AC side anti-backflow control method according to an embodiment of the present disclosure includes the steps of:
step S1, obtaining an electrical parameter of an intelligent microgrid;

In some embodiments, the electrical parameter includes a power Pw of the power grid side that is collected in real time, a set power P1 of the battery system side at the previous moment, a set power P2 of the current battery system side and the set power Pc of the current power grid side.

The power Pw of the power grid side that is collected in real time may be obtained through various detection or sampling circuits, for example, the power may be directly calculated by a power meter, the power may be calculated by sampling voltage and current, etc. In the present embodiment, the power Pw of the power grid side is specifically collected by an AC transformer.

The set power of the battery system side and the set power of the power grid side are set powers obtained according to a relevant control strategy of the intelligent microgrid.
Step S2, calculating a correction coefficient according to the electrical parameter, and performing correction and control on power of a battery system side according to the correction coefficient.

In some embodiments, the correction coefficient A is calculated according to the power Pw of the power grid side that is collected in real time and the set power P1 of the battery system side at the previous moment, and the set power of the battery system side is adjusted and issued to the battery system side according to the set power P2 of the current battery system side and the formula of P=A*P2. The correction coefficient A calculated to prevent backflow is calculated according to the formula A=(Pw−Pc)/P1.

Further, the set power of the battery system side is Specifically the power set by the EMS to the PCS (Power Conversion System), i.e., P1 is the power at the previous moment set by the EMS to the PCS according to the control strategy, P2 is the power at the current time segment set by the EMS to the PCS according to the control strategy, and P is the corrected control power actually issued by the EMS to the PCS. The EMS has the function of setting charge and discharge power of the PCS in the time segmented configuration, and can issue power instruction to the PCS through setting time segments and the power in the time segmented configuration.

Specifically, for example, at a certain moment, the power set by the EMS to the PCS is P1, and the PCS will work according to the power of P1; and when the set control power of the power grid side is Pc, the power collected by the power grid side is Pw, and the correction coefficient is calculated by the EMS, A=(Pw−Pc)/P1. When Pw−Pc is 0, the correction coefficient A is set to 0, i.e., the system operates as set in advance, and the system is not changed. When the preset load power deviates from the set value, the power Pw collected by the power grid side changes, and the correction coefficient is calculated by the EMS, A=(Pw−Pc)/P1, and at this moment, the correction coefficient A is not 0; if there is no change in the ratio between the power instruction set by the EMS to the PCS and that of the previous moment, P2=P1, and then the final power issued by the EMS to the PCS is P=A*P2=Pw−Pc; when there is a change in the ratio between the power instruction set by the EMS to the PCS and that of the previous moment, P2≠P1, and then the final power issued by the EMS to the PCS is P=A*P2=(Pw−Pc)*P2/P1.

Since there is only one instruction for the EMS to send power to the PCS, if the power set in the time segmented configuration and the correction power collected in real time are sent at the same time, the PCS will be too confused to determine which power to follow. By utilizing the correction coefficient, it is ensured that the PCS operates on the basis of an originally set EMS power, and it is also ensured that when the PCS power of the EMS in a time segmented configuration changes, an adjustment power that collects power feedback in real-time changes following the power of the PCS in the time segmented configuration. The embodiment of the present application ensures that power issued by the EMS does not conflict with power to be adjusted that is collected in real time, and the PCS operates in accordance with the originally set power, only performing correction by multiplying the power by a coefficient.

When the duration T that Pw<Pr exceeds Tc, that is T>Tc, it indicates that there is also backflow power after power control by the PCS, the first AC contactor between the power grid side and the intelligent microgrid is cut off by the EMS timely to ensure that there is no current flowing back to the power grid and ensure the stability of the power grid.

Pr and Tc are both set values, Pr is usually set to 0 when there is no zero offset, and is actually changed according to the zero offset to perform correction and guarantee control when there is zero offset, and Tc is Specifically set to is in the present embodiment.

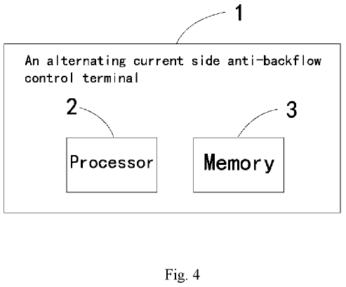

With reference to FIG. 4, the second embodiment of the present disclosure is: an AC side anti-backflow control terminal 1, including a memory 3, a processor 2 and a computer program stored on the memory 3 and executable on the processor 2, the processor 2 implementing the steps of the above-mentioned first embodiment when executing the computer program.

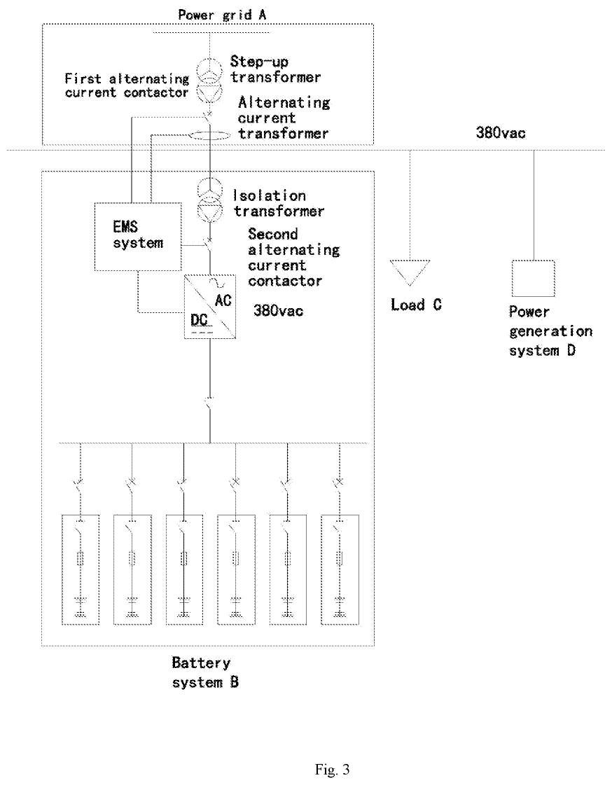

With reference to FIG. 3, the present disclosure is used to control an intelligent microgrid system as illustrated in FIG. 3, which mainly includes a power grid, a battery system, a load, a power generation system, an AC bus, a PCS, and an EMS. The battery system is hung on the AC bus through the PCS, and the load and the power generation system are also hung on the AC bus. The EMS controls the operation of the PCS.

The load, which may be a civil load or a commercial load, or may be in various combinations, and the total value of different loads fitted together, is always in a fluctuating state.

The power generation system, which may be different power generation systems such as photovoltaic power generation, wind power generation, diesel power generation or hydrogen fuel power generation, or may be a combination of various power generation systems, and the total value of different power generation powers fitted together, is also always in a fluctuating state.

When the AC bus is used for capacity expansion, the EMS needs to mobilize the energy of the energy storage system according to the data collected in real time because of the fluctuation of the load and the power generation system. Further, an AC transformer provided on the power grid side and electrically connected to the EMS is also included. The AC transformer collects power of the power grid side in real time and outputs same to the EMS.

Further, a first AC contactor, a second AC contactor, an isolation transformer and a step-up transformer are included. The AC bus is electrically connected to the power grid via the first AC contactor and the step-up transformer, and the AC bus is electrically connected to the load and the power generation system, and the AC bus is electrically connected to the battery system bus via the isolation transformer, the second AC contactor and the PCS. The EMS is electrically connected to the first AC contactor and the second AC contactor respectively, switches between grid connection and grid disconnection, and performs necessary protection.

In summary, the present disclosure provides an AC side anti-backflow control method and a terminal. By utilizing the correction coefficient, it is ensured that the battery system side operates on the basis of an originally set power, and it is also ensured that when the power of the battery system side in a time segmented configuration changes, an adjustment power that collects power feedback in real-time changes following the power of the battery system side in the time segmented configuration; said strategy ensures that issued power does not conflict with power to be adjusted that is collected in real time, and the battery system side operates in accordance with the originally set power, only performing correction by multiplying the power by a coefficient. When the duration T that Pw<Pr exceeds Tc, that is T>Tc, it indicates that there is also backflow power after power control, the electrical connection between the power grid side and the intelligent microgrid is cut off timely to ensure that there is no current flowing back to the power grid and ensure the stability of the power grid.

The foregoing is only an embodiment of the present disclosure and is not intended to limit the scope of the present disclosure. Any equivalent changes made by using the contents of the description and drawings of the present disclosure, or directly or indirectly applied in the relevant technical fields, are similarly included in the scope of patent protection of the present disclosure.

What is claimed is:

1. An AC side anti-backflow control method, comprising:
step S1, obtaining an electrical parameter of an intelligent microgrid; and
step S2, calculating a correction coefficient according to the electrical parameter, and performing correction and control on power of a battery system side of the intelligent microgrid according to the correction coefficient.

2. The AC side anti-backflow control method according to claim 1, wherein the electrical parameter comprises a power of a power grid side of the intelligent microgrid that is collected in real time, a set power of the battery system side, and a set power of the power grid side.

3. The AC side anti-backflow control method according to claim 2, wherein in the step S2:
a correction coefficient is calculated and obtained according to a formula A=(Pw−Pc)/P1, where A is the correction coefficient, Pw is a power of the power grid side that is collected in real time, P1 is a set power of the battery system side at the previous moment, and Pc is a set power of a current power grid side; and
correction and control are performed on a power of the battery system side of the intelligent microgrid according to a formula P=A*P2, wherein P2 is a set power of the battery system side at the current moment, and P is a power set by a command sent to the battery system side.

4. The AC side anti-backflow control method according to claim 1, wherein when a power of a power grid side that is collected in real time is less than a set power of a power grid backflow, and the duration exceeds a set backflow time, the intelligent microgrid is controlled to cut off the electrical connection with the power grid.

5. The AC side anti-backflow control method according to claim 1, wherein a set power of a current battery system side and a set power of a current power grid side are set according to a current time segment.

6. An AC side anti-backflow control terminal, comprising a memory, a processor and a computer program stored on the memory and executable on the processor, wherein the processor implements the following steps when executing the computer program:
step S1, obtaining an electrical parameter of an intelligent microgrid; and
step S2, calculating a correction coefficient according to the electrical parameter, and performing correction and control on power of a battery system side of the intelligent microgrid according to the correction coefficient.

7. The AC side anti-backflow control terminal according to claim 6, wherein the electrical parameter comprises a power of a power grid side of the intelligent microgrid that is collected in real time, a set power of the battery system side, and a set power of the power grid side.

8. The AC side anti-backflow control terminal according to claim 7, wherein in the step S2:
a correction coefficient is calculated and obtained according to a formula A=(Pw−Pc)/P1, where A is the correction coefficient, Pw is a power of the power grid side that is collected in real time, P1 is a set power of the battery system side at the previous moment, and Pc is a set power of a current power grid side; and
correction and control are performed on a power of the battery system side of the intelligent microgrid according to a formula P=A*P2, wherein P2 is a set power of the battery system side at the current moment, and P is a power set by a command sent to the battery system side.

9. The AC side anti-backflow control terminal according to claim 6, wherein when a power of a power grid side that is collected in real time is less than a set power of a power grid backflow, and duration exceeds a set backflow time, the intelligent microgrid is controlled to cut off the electrical connection with the power grid.

10. The AC side anti-backflow control terminal according to claim 6, wherein a set power of a current battery system side and a set power of a current power grid side are set according to a current time segment.
